(19) United States
(12) Patent Application Publication
(10) Pub. No.: US 2022/0172056 A1
(43) Pub. Date: Jun. 2, 2022

(54) PREDICTION SYSTEM, PREDICTION METHOD, AND PREDICTION PROGRAM

(71) Applicant: NATIONAL UNIVERSITY CORPORATION SHIZUOKA UNIVERSITY, Shizuoka-shi, Shizuoka (JP)

(72) Inventors: Hiroshi MINENO, Hamamatsu-shi, Shizuoka (JP); Kazumasa WAKAMORI, Hamamatsu-shi, Shizuoka (JP); Gota NAKANISHI, Hamamatsu-shi, Shizuoka (JP)

(21) Appl. No.: 17/601,731

(22) PCT Filed: Apr. 16, 2020
(86) PCT No.: PCT/JP2020/016740

§ 371 Date: Oct. 6, 2021

(30) Foreign Application Priority Data
Apr. 25, 2019 (JP) 2019-084098

(51) Int. Cl. G06N 3/08; G06N 3/04; A01G 25/16

(52) U.S. Cl. CPC G06N 3/08; A01G 25/16; G06N 3/04

(57) ABSTRACT

A prediction system according to an embodiment is configured to: acquire a plurality of input vectors indicating a combination of an object feature represented by one or more feature quantities related to a state of an object calculated based on an observation and an environmental feature represented by one or more feature quantities related to a surrounding environment of the object; divide a set of the environmental features into a plurality of clusters by clustering; and executing machine learning for each of the plurality of input vectors to generate a machine learning model for predicting state of object. The machine learning includes: executing processing based on the cluster to which the environmental feature of the input vector belongs; and outputting a predictive value of the state of the object by inputting the input vector into the machine learning model on which the processing is executed.

### TECHNICAL FIELD

One aspect of the present disclosure relates to a prediction system, a prediction method, and a prediction program.

### BACKGROUND ART

Computer systems are known that predict a state of an object by machine learning. For example, Patent Document 1 discloses a plant disease diagnosis system. This system includes a deep learning device that receives a plurality of images of plant diseases and corresponding diagnosis results as learning data, and creates and stores image feature data related to plant diseases, an input unit that inputs an image to be diagnosed, an analysis unit that identifies into which diagnosis result the input image is classified using the deep learning device, and a display unit that displays a diagnosis result output by the analysis unit.

### CITATION LIST

### Patent Literature

[Patent Document 1] JP 2016-168046 A

### SUMMARY OF INVENTION

### Technical Problem

It is desirable to accurately predict a state of an object. For example, since the state of the plant can be accurately grasped by predicting a water stress of the plant, it is desired to accurately predict the water stress.

### Solution to Problem

A prediction system according to an aspect of the present disclosure includes at least one processor. The at least one processor is configured to: acquire a plurality of input vectors indicating a combination of an object feature represented by one or more feature quantities related to a state of an object calculated based on an observation and an environmental feature represented by one or more feature quantities related to a surrounding environment of the object; divide a set of the environmental features into a plurality of clusters by clustering; and execute machine learning for each of the plurality of input vectors to generate a machine learning model for predicting state of object. The machine learning includes: executing processing based on the cluster to which the environmental feature of the input vector belongs; and outputting a predictive value of the state of the object by inputting the input vector into the machine learning model on which the processing is executed.

In this aspect, the cluster-based processing provides the machine learning model that dynamically changes according to various surrounding environments. By using the machine learning model, the surrounding environment that affects the state of the object is sufficiently considered, and thus the state of the object can be accurately predicted.

### Advantageous Effects of Invention

According to an aspect of the present disclosure, it is possible to accurately predict a state of an object.

### BRIEF DESCRIPTION OF DRAWINGS

FIG. 1. is a diagram showing an example of a functional configuration of a prediction system according to an embodiment.

FIG. 2. is a diagram showing an example of a configuration related to a machine learning model.

FIG. 3. is a diagram showing an example of a hardware configuration of a computer used in the prediction system according to the embodiment.

FIG. 4. is a flowchart showing an example of generating a learned model.

FIG. 5. is a flowchart showing an example of generating a mask vector.

FIG. 6. is a diagram showing a specific example of generating mask vectors.

FIG. 7. is a diagram showing another example of generating mask vectors.

FIG. 8. is a flowchart showing an example of predicting a water stress.

FIG. 9. is a diagram showing an example of use of an irrigation control system according to an embodiment.

FIG. 10. is a diagram showing a functional configuration of the irrigation control system according to the embodiment.

### DESCRIPTION OF EMBODIMENTS

Hereinafter, embodiments of the present disclosure will be described in detail with reference to the accompanying drawings. In the description of the drawings, the same or equivalent element is denoted by the same reference numeral, and redundant description is omitted.

System Overview

The prediction system 1 according to an embodiment is a computer system that predicts a state of an object. In one example, the object is a plant. In this case, the state of the object may be a growing condition of the plant, and more specifically, may be a water stress of the plant. The object and the “state of object” are however not limited.

In one example, the prediction system 1 is a computer system that predicts the water stress of a plant. The type of plant is not limited, and the plant may be cultivated or naturally grown. The water stress refers to a degree of water deficiency in the plant. It can therefore be said that the water stress is an index indicating a degree of moisture in the plant. The prediction system 1 represents the water stress with a physical parameter. Examples of the physical parameter include, but are not limited to, the diameter of stein or the amount of change therein, the inclination of stein or the amount of change therein, the spread of leaf or the amount of change therein, the color tone of leaf or the amount of change therein, and the like. The prediction system 1 may express the water stress using a plurality of types of physical parameters. In one example, the prediction system 1 expresses the water stress with the diameter of stein or the amount of change therein. The prediction system 1 outputs a predicted result of the water stress of the plant as a predictive value. The predictive value output from the prediction system 1 can be used for various purposes, and thus the method of using or applying the prediction system 1 is not limited. For example, the prediction system 1 can be used for various purposes such as irrigation control, air conditioning control, and harvest prediction.

The prediction system 1 uses machine learning to predict the state of the object (more specifically, to predict the water stress of the plant). The machine learning is a method of autonomously finding a law or a rule by repeatedly executing learning based on given information. A specific method of machine learning is not limited. In one example, the prediction system 1 executes machine learning using a machine learning model that is a computational model including a neural network. The neural network is an information processing model that mimics the mechanism of human brain nervous system. The type of neural network used in the prediction system 1 is not limited. For example, a convolutional neural network (CNN), a recurrent neural network (RNN), or a long short-term memory (LSTM) may be used.

The prediction system 1 may train a machine learning model by repeating learning and acquire the machine learning model as a learned model. This corresponds to the learning phase. It should be noted that the learned model is a machine learning model expected to be optimal for predicting the water stress of plant, and is not necessarily a “machine learning model that is optimal in reality”. The prediction system 1 may also output a predictive value of water stress by processing an input vector (i.e., input data) using the learned model. This corresponds to the prediction phase or the operation phase. The prediction system 1 may execute further processing based on the predictive value.

The learned model is portable between computer systems. Thus, a learned model generated in one computer system may be used in another computer system. Of course, one computer system may execute both the generation and use of the learned model. That is, the prediction system 1 may execute both the learning phase and the prediction phase, or may not execute either the learning phase or the prediction phase.

Configuration of System

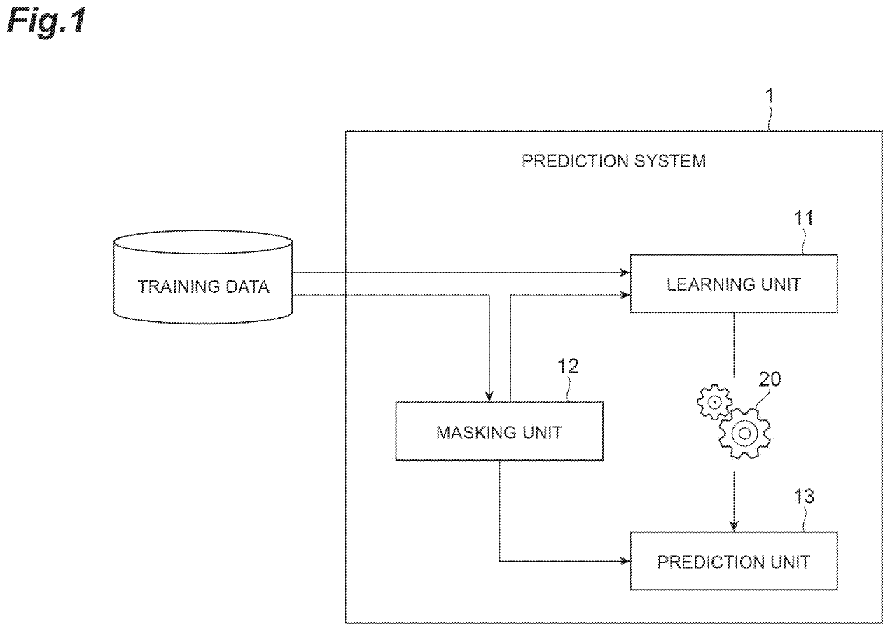

FIG. 1 is a diagram showing an example of a functional configuration of the prediction system 1 according to the embodiment. In one example, the prediction system 1 includes a learning unit 11, a masking unit 12, and a prediction unit 13 as functional elements. The learning unit 11 is a functional element that executes the machine learning using a prepared input vector to generate a learned model 20 for predicting the water stress of plant. The masking unit 12 is a functional element that, in the machine learning, executes masking for disabling some nodes of the neural network of the machine learning model. The prediction unit 13 is a functional element that predicts the water stress of plant using the generated learned model 20. The prediction unit 13 outputs the predictive value of the water stress of plant.

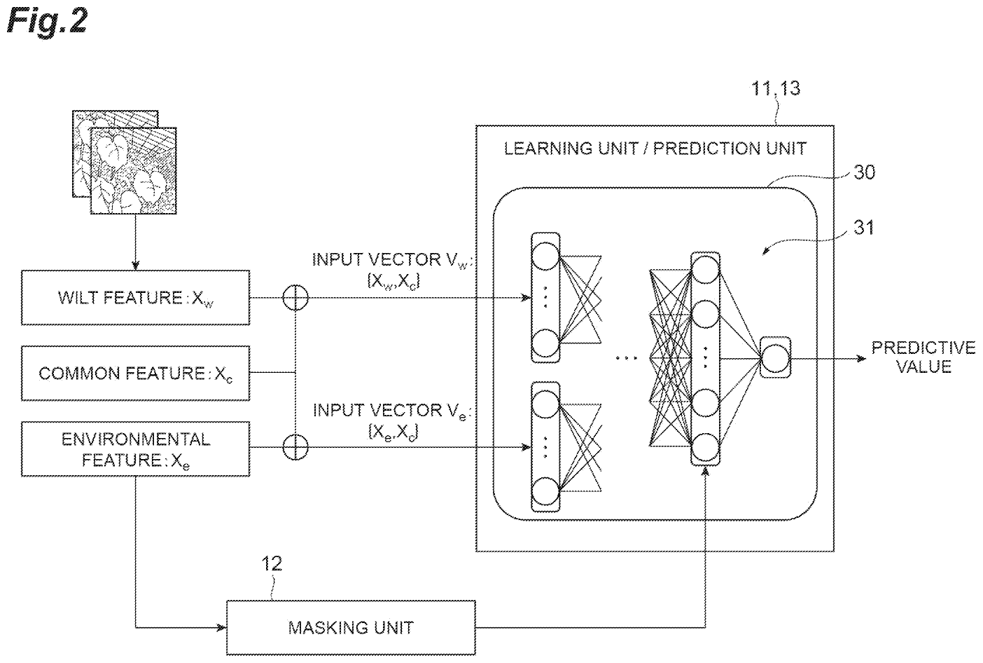

FIG. 2 is a diagram showing an example of a configuration related to the machine learning model (learned model). The machine learning model 30 used by the learning unit 11 or the prediction unit 13 receives an input vector based on three vectors of wilt feature X_{w}, an environmental feature Xₑ, and a common feature X_{c}, and processes the input vector to output a predictive value of the water stress of plant. The wilt feature X_{w}, environmental feature Xₑ, and common feature X_{c} are each a set (vector) of one or more feature quantities. In this operation, the masking unit 12 disables at least one node of a neural network 31 of the machine learning model 30. The disabled node is not used in processing by the neural network 31. In the prediction phase, the machine learning model 30 is the learned model 20.

The wilt feature X_{w} is represented with one or more feature quantities related to the state of the plant calculated based on an image obtained by photographing a plant. (This image is also referred to as “plant image”.) To be more specific, the wilt feature X_{w} is a vector representing a motion of leaves with one or more feature quantities. For example, the wilt feature X_{w} is calculated by the following procedure based on two images corresponding to two time points. First, an optical flow representing a motion of an object with a vector is calculated using the two images corresponding to the two time points. For example, the optical flow may be obtained using an algorithm called DeepFlow, but may be calculated by another method. By applying a method called ExG (Excess Green) to each image, a region represented by the image is divided into a plant region and a region other than the plant region (for example, the sky). By these two processes, only the optical flow of the plant can be obtained. Subsequently, the feature quantity is calculated and set based on the optical flow of the plant.

The plant image is an example of observation. The observation refers to recording a state of an object. The wilt feature is a feature of an object, which is also referred to as an “object feature”.

In one example, the wilt feature X_{w} may be represented by the following 11-dimensional feature quantity. These feature quantities represent a degree of wilting or recovery of leaves.
Histogram of angles of optical flow (Histograms of Oriented Optical Flow (HOOF)) (6-dimension)
Average of angles of optical flow (1-dimension)
Standard deviation of angles of optical flow (1-dimension)
Average of magnitudes of optical flow (1-dimension)
Standard deviation of magnitudes of optical flow (1-dimension)
Detection rate of optical flow (1-dimension)

The HOOF is obtained by normalizing the area of a histogram calculated based on the angles (pins) of the optical flow along the vertical direction and the length (weight) of the optical flow. The number of dimensions of the HOOF being 6 means that the total number of pins is set to 6. The fact that the total number of pins is 6 means that a leaf motion along the vertical direction is distinguished every 30° (=180/6). (Symmetrical optical flows are accumulated on the same pin.) The detection rate of the optical flow is represented by a ratio of the number of detected optical flows to the total number of pixels of the image. The five dimensions other than HOOF are statistics, which represent the distribution of optical flow not represented by HOOF.

The environmental feature Xₑ is represented by one or more feature quantities related to a surrounding environment of the plant. The “surrounding environment of the plant” refers to an environment in a given geographical area that can affect the plant, and is an example of the “surrounding environment of object”. For example, the surrounding environment may be an environment within a few meters or several tens of meters of the plant being observed. Each feature quantity of the environmental feature Xₑ is obtained by measurement with an environmental sensor. In one example, the environmental feature Xₑ may include one or more feature quantities related to a transpiration rate of the plant that is a cause of water stress. For example, the environmental feature Xₑ may be represented by 4-dimensional feature quantities: temperature; relative humidity; vapor pressure deficit; and amount of scattered light (brightness). The vapor pressure deficit is an index indicating how much more moisture can be in the air. Factors determining the transpiration rate include water vapor pressure and degree of stoma opening. The water vapor pressure can be described by temperature, relative humidity, and vapor pressure deficit, and the degree of stomatal opening can be described by the amount of scattered light.

The common feature X_{c} is a feature that complements each of the wilt feature and the environmental feature. In one example, the common feature X_{c} may be represented by a 2-dimensional feature quantities: elapsed time from sunrise and an irrigation flag indicating whether or not irrigation has been performed with two values. The common feature X_{c} may be omitted.

The wilt feature X_{w}, environmental feature Xₑ, and common feature X_{c} are provided as time series data collected at given time intervals (e.g., every one minute, every 5 minutes, every 10 minutes, etc.). The learning unit 11 and the prediction unit 13 input an input vector V_{w} that is a combination of the wilt feature X_{w} and the common feature X_{c} corresponding to one time point, and an input vector Vₑ that is a combination of the environmental feature Xₑ and the common feature X_{c} corresponding to that time point, into the machine learning model 30. In case that the wilt feature X_{w}, environmental feature Xₑ, and common feature X_{c} are 11-dimensional, 4-dimensional, and 2-dimensional, respectively, the input vector V_{w} is 13-dimensional and the input vector Vₑ is 6-dimensional. The neural network 31 of the machine learning model 30 may be a multimodal neural network that processes these two types of input vectors V_{w} and Vₑ. For example, the neural network 31 may be a multi-modal neural network using Two stream LSTM (2sLSTM) or Cross-modal LSTM (X-LSTM). In any case, both the learning unit 11 and the prediction unit 13 obtain the predictive value of the water stress of plant from the input vectors V_{w} and Vₑ.

The specific configuration of each of the wilt feature, environmental feature, and common feature is not limited to the above examples. For example, at least one feature quantity of the wilt feature may be calculated or set without using optical flow. The environmental feature may not include at least one of the four feature quantities of temperature, relative humidity, vapor pressure deficit, and the amount of scattered light, and may include a feature quantity different from the four feature quantities. The common feature may not include at least one of two types of feature quantities of the elapsed time from sunrise and the irrigation flag, and may include a feature quantity different from the two types of feature quantities.

Some nodes of the neural network 31 for obtaining a predictive value from the input vectors V_{w} and Vₑ are disabled by the masking unit 12. The masking unit 12 executes preprocessing to divide a set of environmental features Xₑ into a plurality of clusters by clustering and disable some nodes corresponding to each cluster. The masking unit 12 disables some nodes of the neural network 31 based on the cluster to which the environmental feature Xₑ of the input vector Vₑ belongs. In the present disclosure, this disablement is also referred to as “masking”. The learning unit 11 or the prediction unit 13 outputs the predictive value by inputting the input vector to the machine learning model 30 on which the masking is executed.

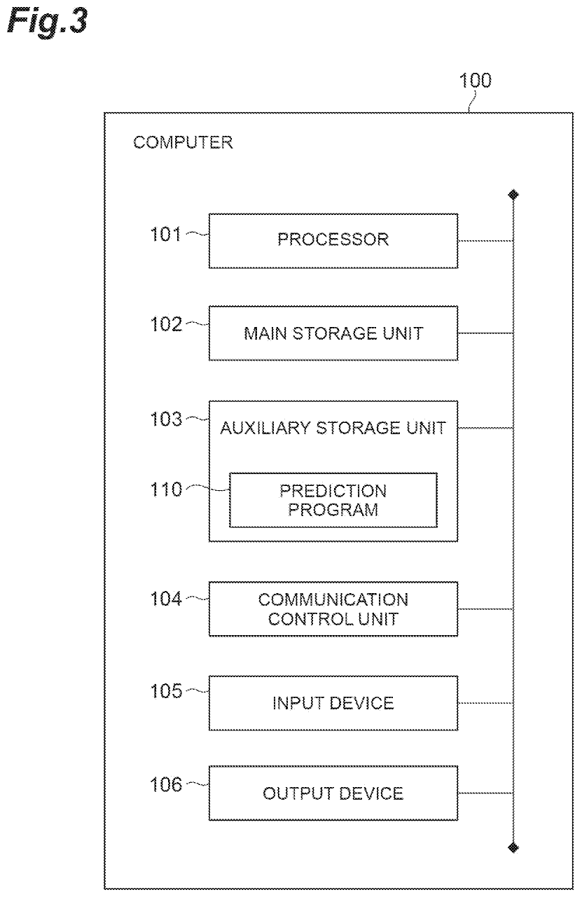

FIG. 3 is a diagram showing an example of a general hardware configuration of a computer 100 included in the prediction system 1 according to the embodiment. For example, the computer 100 includes a processor 101, a main storage unit 102, an auxiliary storage unit 103, a communication control unit 104, an input device 105, and an output device 106. The processor 101 executes an operating system and application programs. The main storage unit 102 includes, for example, a ROM and a RAM. The auxiliary storage unit 103 is constituted by, for example, a hard disk or a flash memory, and generally stores a larger amount of data than the main storage unit 102. The communication control unit 104 includes, for example, a network card or a wireless communication module. The input device 105 includes, for example, a keyboard, a mouse, and a touch panel. The output device 106 includes, for example, a monitor and a speaker.

Each functional element of the prediction system 1 is realized by a prediction program 110 stored in advance in the auxiliary storage unit 103. Specifically, each functional element is realized by causing the processor 101 or the main storage unit 102 to read the prediction program 110 and causing the processor 101 to execute the prediction program 110. The processor 101 operates the communication control unit 104, the input device 105, or the output device 106 according to the prediction program 110, and reads and writes data in the main storage unit 102 or the auxiliary storage unit 103. Data or databases required for processing may be stored in the main storage unit 102 or the auxiliary storage unit 103.

The prediction program 110 may be provided after being fixedly recorded on a tangible recording medium such as a CD-ROM, a DVD-ROM, or a semiconductor memory. Alternatively, the prediction program 110 may be provided as a data signal superimposed on a carrier wave via a communication network.

The prediction system 1 may be constructed with a single computer 100 or a plurality of computers 100. In case that a plurality of computers 100 are used, these computers 100 are connected via a communication network such as the Internet or an intranet, thereby constructing logically one prediction system 1.

The type of the computer 100 is not limited. For example, the computer 100 may be a stationary or portable personal computer (PC), a workstation, or a portable terminal such as a high-performance mobile phone (smart phone), a mobile phone, or a personal digital assistant (PDA). The prediction system 1 may be constructed by combining a plurality of types of computers.

System Operation

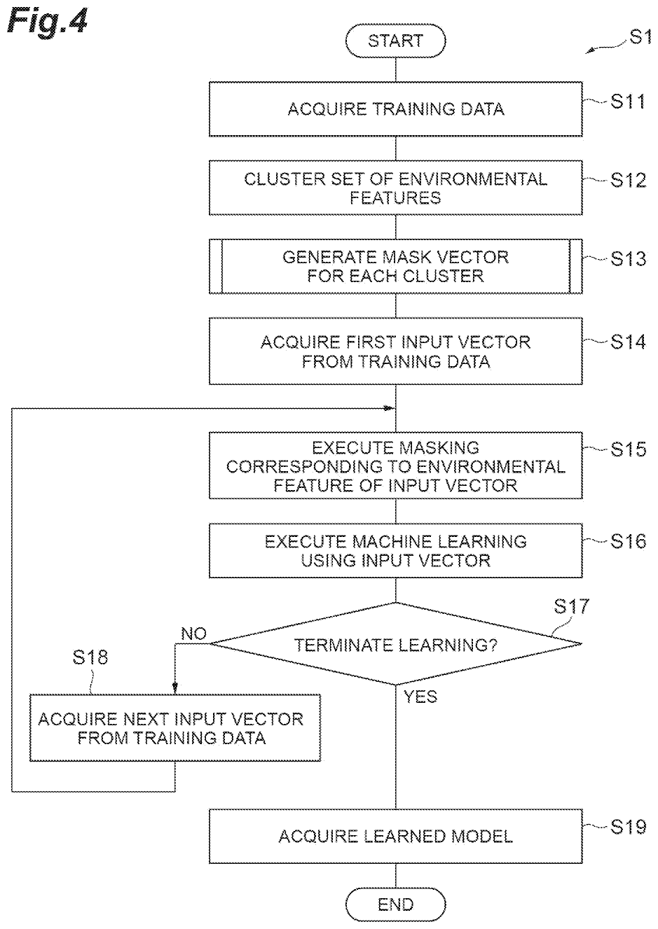

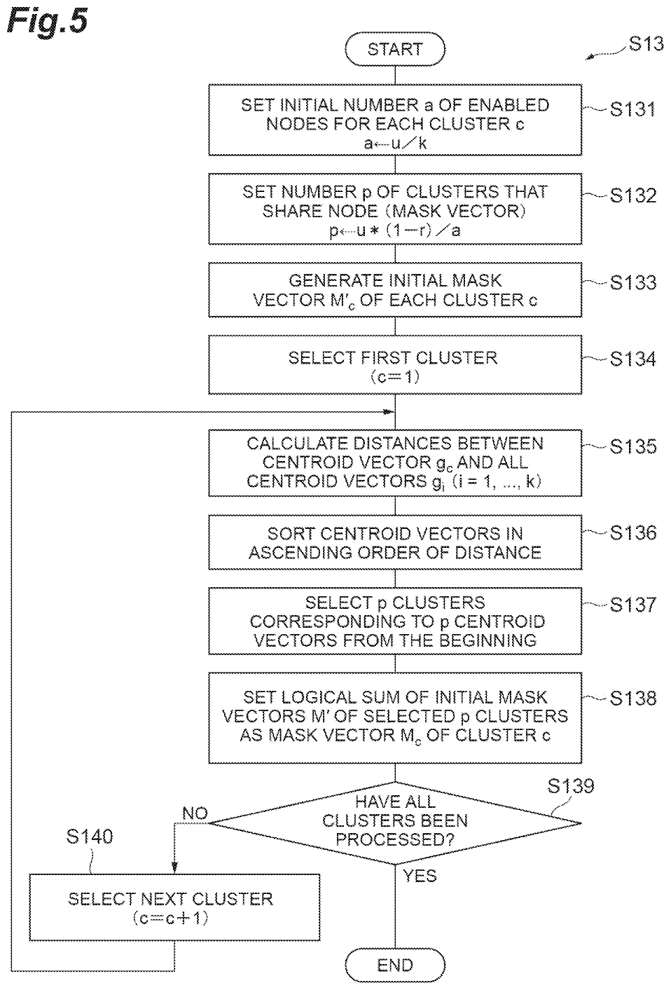

The generation of the learned model 20 will be described with reference to FIGS. 4 and 5. FIG. 4 is a flowchart showing an example of generating the learned model 20 as a processing flow S1. FIG. 5 is a flowchart showing an example of generating a mask vector, which constitutes a part of the processing flow S1. The processing flow S1 corresponds to the learning phase and is an example of a prediction method according to the present disclosure.

In step S11, the learning unit 11 acquires training data. The method of acquiring the training data is not limited. For example, the learning unit 11 may access a given database to read the training data, or may receive the training data transmitted from another computer. Alternatively, the learning unit 11 may use the training data generated by processing in the prediction system 1. In one example, the training data is time series data obtained by collecting a combination of the wilt feature, environmental feature, common features, and measured values of water stress at given time intervals.

In step S12, the masking unit 12 clusters a set of environmental features included in the training data to divide the set into a plurality of clusters. The clustering method is not limited. For example, the masking unit 12 converts the environmental feature into an environmental feature space including only features effective for clustering, by a nonlinear mapping using kernel approximation and principal component analysis (PCA). The masking unit 12 then divides the converted environmental feature into k clusters using the k-means method. The masking unit 12 also determines the set G={g₁, g₂, . . . , gₖ} of the centroid vectors of the individual clusters.

In step S13, the masking unit 12 generates a mask vector for each of the generated clusters. The mask vector is a vector indicating which node among a plurality of nodes constituting the neural network 31 is to be disabled. In one example, the masking unit 12 generates the mask vector for disabling some of the plurality of nodes constituting a fully connected layer of the neural network 31. The masking unit 12 may generate the mask vector for each of all fully connected layers of the neural network 31 or may generate the mask vector for only some fully connected layers.

The processing for generating the mask vector will be described in detail with reference to FIG. 5. In step S131, the masking unit 12 sets the initial number a of enabled nodes for each cluster c. The initial number of enabled nodes refers to an initial value of the number of nodes to be enabled (i.e., nodes used in processing by the neural network 31) among a plurality of nodes that may be disabled (hereinafter, such nodes are also referred to as “target node”). For example, the plurality of target nodes are a plurality of nodes constituting the fully connected layer. The initial number a of enabled nodes is represented by a=u/k, where u denotes the number of target nodes and k denotes the number of clusters.

In step S132, the masking unit 12 sets the number p of clusters that share a node (mask vector). This value p is represented by p=u*(1−r)/a, using the drop rate r. The drop rate is a ratio of nodes to be disabled among a plurality of target nodes.

In step S133, the masking unit 12 generates an initial mask vector M′_{c} of each cluster c. The initial mask vector is an initial value of the mask vector. Nodes are enabled by using each initial mask vector M′_{c}. Enabled nodes are different for each of k initial mask vectors M′_{c} (c=1 to k), which means that initial values of the plurality of mask vectors corresponding to the plurality of clusters are different from each other.

After generating the initial mask vector M′_{c} of each cluster c, the masking unit 12 generates a mask vector M_{c} for each cluster c. In step S134, the masking unit 12 selects the first cluster c, and executes the following processing for this cluster.

In step S135, the masking unit 12 calculates distances between the centroid vector g_{c} of the selected cluster c and all the centroid vectors gᵢ (i=1 to k). The distance between centroid vectors may be a Euclidean distance or may be represented by another type of distance. In step S136, the masking unit 12 sorts the k centroid vectors in ascending order of the distance. The centroid vector g_{c} of the selected cluster c is positioned at the beginning of the centroid vector sequence. In step S137, the masking unit 12 selects p centroid vectors from the beginning of the sorted centroid vectors, and selects p clusters corresponding to the selected centroid vectors. In step S138, the masking unit 12 sets a logical sum of the initial mask vectors M′ of the selected p clusters as the mask vector M_{c} corresponding to the selected cluster c. In short, the series of processing of steps S135 to S138 is processing for setting a logical sum of an initial mask vector of a reference cluster and an initial mask vector of each of one or more clusters located in the vicinity of the reference cluster, as a mask vector of the reference cluster.

As shown in step S139, the masking unit 12 sets the mask vector M_{c} for all the clusters c. In case that there is an unprocessed cluster (NO in step S139), the processing proceeds to step S140, and the masking unit 12 selects the next cluster c and executes the processing of steps S135 to S 138 for that cluster c. In case that all the clusters c have been processed (YES in step S139), the processing of step S13 ends.

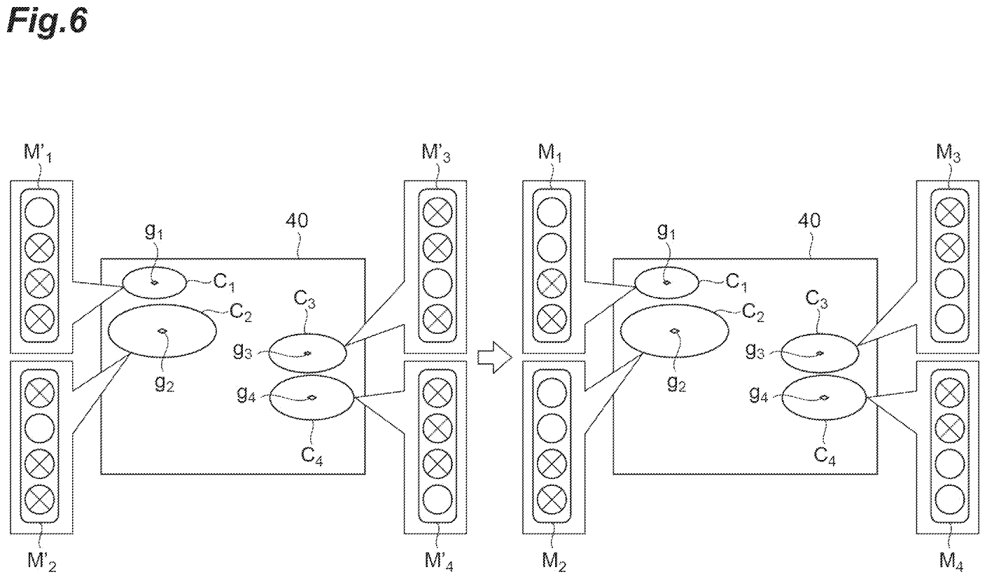

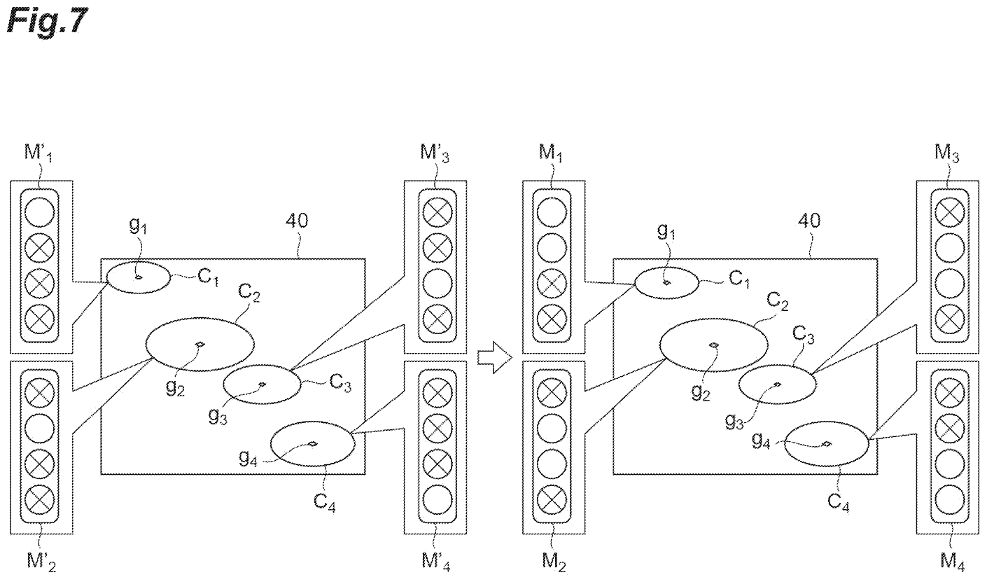

FIGS. 6 and 7 are diagrams showing specific examples of generating the mask vector. In these examples, it is assumed that the number k of clusters is 4, the number u of target nodes is 4, and the drop rate r is 0.5. Therefore, the masking unit 12 disables two nodes and enables the remaining two nodes.

First, the example shown in FIG. 6 will be described. In this example, a cluster C₁ having a centroid vector g₁, a cluster C₂ having a centroid vector g₂, a cluster C₃ having a centroid vector g₃, and a cluster C₄ having a centroid vector g₄ exist in an environmental feature space 40. Since u=4, k=4, and r=0.5, a=1 (step S131) and p=2 (step S132). Since the initial number a of enabled nodes is 1, the masking unit 12 sets each initial mask vector M′_{c} such that the number of enabled nodes of the initial mask vector M′_{c} of each cluster c becomes 1 (step S133). Assuming that the enabled node is represented by “1” and the disabled node is represented by “0”, the masking unit 12 sets the initial mask vectors M′_{c} (c=1 to 4) as follows, for example.
M′₁={1, 0, 0, 0}
M′₂={0, 1, 0, 0}
M′₃={0, 0, 1, 0}
M′₄={0, 0, 0, 1}

The left of FIG. 6 shows the initial mask vectors. In FIGS. 6 and 7, each node is indicated by a circle, and a disabled node is marked with a x-mark.

From the arrangement of the clusters shown in FIG. 6, in case that the centroid vectors are arranged in ascending order of the distance with respect to the cluster C₁, the order becomes g₁, g₂, g₃, and g₄ (step S136).

The masking unit 12 therefore selects two clusters C₁ and C₂ corresponding to the two centroid vectors g₁ and g₂ (step S137). Then, the masking unit 12 sets a logical sum of the initial mask vectors M′₁ and M′₂ of the two clusters as a mask vector M₁ of the cluster C₁ (step S138). Based on the above-described examples of the initial mask vectors, the masking unit 12 sets the mask vector M₁ as {1, 1, 0, 0}.

The masking unit 12 sets the mask vector for the other clusters in the same manner. In case that the centroid vectors are arranged in ascending order of the distance with respect to the cluster C₂, the order becomes g₂, g₁, g₃, and g₄. The masking unit 12 therefore selects two clusters C₂ and C₁ corresponding to the two centroid vectors g₂ and g₁. The masking unit 12 then sets a logical sum of the initial mask vectors M′₂ and M′₁ of the two clusters as a mask vector M₂ of the cluster C₂. That is, M₂={1, 1, 0, 0}.

In case that the centroid vectors are arranged in ascending order of the distance with respect to the cluster C₃, the order becomes g₃, g₄, g₂, and g₁. The masking unit 12 therefore selects two clusters C₃ and C₄ corresponding to the two centroid vectors g₃ and g₄. The masking unit 12 then sets a logical sum of the initial mask vectors M′₃ and M′₄ of the two clusters as a mask vector M₃ of the cluster C₃. That is, M₃={0, 0, 1, 1}.

In case that the centroid vectors are arranged in ascending order of the distance with respect to the cluster C₄, the order becomes g₄, g₃, g₂, and g₁. The masking unit 12 therefore selects two clusters C₄ and C₃ corresponding to the two centroid vectors g₄ and g₃. The masking unit 12 then sets a logical sum of the initial mask vectors M′₄ and M′₃ of the two clusters as a mask vector M₄ of the cluster C₄. That is, M₄={0, 0, 1, 1}.

The following mask vectors M_{c} (c=1 to 4) is obtained by the above processing. This means that clusters C₁ and C₂ share the nodes (mask vector), and clusters C₃ and C₄ share the nodes (mask vector). The right of FIG. 6 shows those mask vectors.

### M₁={1, 1, 0, 0}

### M₂={1, 1, 0, 0}

### M₃={0, 0, 1, 1}

### M₄={0, 0, 1, 1}

Next, the example shown in FIG. 7 will be described. The precondition of this example is the same as the example of FIG. 6 except for a position of each cluster in the environmental feature space 40. That is, u=4, k=4, r=0.5, a=1, and p=2. Also in this example, it is assumed that the masking unit 12 sets the initial mask vectors M′_{c} (c=1 to 4) as follows (see the left of FIG. 7).

### M′₁={1, 0, 0, 0}

### M′₂={0, 1, 0, 0}

### M′₃={0, 0, 1, 0}

### M′₄={0, 0, 0, 1}

From the arrangement of the clusters shown in FIG. 7, in case that the centroid vectors are arranged in ascending order of the distance with respect to the cluster C₁, the order becomes g₁, g₂, g₃, and g₄. The masking unit 12 therefore selects two clusters C₁ and C₂ corresponding to the two centroid vectors g₁ and g₂. Then, the masking unit 12 sets a logical sum of the initial mask vectors M′₁ and M′₂ of the two clusters as a mask vector M₁ of the cluster C₁. That is, the masking unit 12 sets the mask vector M₁ as {1, 1, 0, 0}.

In case that the centroid vectors are arranged in ascending order of the distance with respect to the cluster C₂, the order becomes g₂, g₃, g₁, and g₄. The masking unit 12 therefore selects two clusters C₂ and C₃ corresponding to the two centroid vectors g₂ and g₃. The masking unit 12 then sets a logical sum of the initial mask vectors M′₂ and M′₃ of the two clusters as a mask vector M₂ of the cluster C₂. That is, M₂={0, 1, 1, 0}.

In case that the centroid vectors are arranged in ascending order of the distance with respect to the cluster C₃, the order becomes g₃, g₂, g₄, and g₁. The masking unit 12 therefore selects two clusters C₃ and C₂ corresponding to the two centroid vectors g₃ and g₂. The masking unit 12 then sets a logical sum of the initial mask vectors M′₃ and M′₂ of the two clusters as a mask vector M₃ of the cluster C₃. That is, M₃={0, 1, 1, 0}.

In case that the centroid vectors are arranged in ascending order of the distance with respect to the cluster C₄, the order becomes g₄, g₃, g₂, and g₁. The masking unit 12 therefore selects two clusters C₄ and C₃ corresponding to the two centroid vectors g₄ and g₃. The masking unit 12 then sets a logical sum of the initial mask vectors M′₄ and M′₃ of the two clusters as a mask vector M₄ of the cluster C₄. That is, M₄={0, 0, 1, 1}.

The following mask vectors M_{c} (c=1 to 4) is obtained by the above processing. This means that clusters C₂ and C₃ share the nodes (mask vector), clusters C₁ and C₂ share some nodes (a part of mask vector), and clusters C₃ and C₄ share some nodes (a part of mask vector). The right of FIG. 7 shows those mask vectors.

### M₁={1, 1, 0, 0}

### M₂={0, 1, 1, 0}

### M₃={0, 1, 1, 0}

### M₄={0, 0, 1, 1}

As described above, by generating the mask vector corresponding to the cluster of the environmental feature, a plurality of subnetworks corresponding to a plurality of clusters can be generated in the neural network 31. This means generating subnetworks according to the classification of surrounding environment. Since each subnetwork executes learning exclusively for the corresponding surrounding environment, it is possible to generate the learned model 20 that dynamically adapts to various surrounding environments.

Returning to FIG. 4, in step S14, the learning unit 11 acquires a first input vector from the training data. As described above, in one example, the input vector is configured using an input vector that is a combination of the wilt feature and the common feature and an input vector that is a combination of the environmental feature and the common feature.

In step S15, the masking unit 12 executes masking corresponding to the environmental feature of the acquired input vector. Specifically, the masking unit 12 selects the cluster c to which the environmental feature belongs from k clusters, and disables some nodes in the neural network 31 according to the mask vector M_{c} corresponding to the cluster c. In one example, the masking unit 12 disables some of the nodes constituting the fully connected layer.

In step S16, the learning unit 11 executes the machine learning using the input vector. Specifically, the learning unit 11 inputs the input vector into the machine learning model 30 on which the masking is executed, and obtains a predictive value output from the machine learning model 30. The learning unit 11 then updates parameters in the machine learning model 30 by using a method such as back propagation, based on an error between the predictive value and an actually measured value (i.e., ground truth) of the water stress of the plant corresponding to the input vector. An example of the parameter to be updated in the machine learning model is weights of the neural network 31. However, the parameters to be updated are not limited thereto.

In step S17, the learning unit 11 determines whether to terminate the learning. The learning unit 11 terminates the learning in case that a termination condition of the machine learning is satisfied, and continues the machine learning when the termination condition is not satisfied. The termination condition may be set optionally. For example, the learning unit 11 may evaluate a performance of the machine learning model using verification data and terminate the machine learning when the evaluation satisfies a given criterion. Alternatively, the termination condition may be set based on an error, or may be set based on the number of input vectors to be processed, i.e., the number of times of learning.

In case that the learning is continued (NO in step S17), in step S18, the learning unit 11 acquires a next input vector from the training data, and executes the processing of steps S15 and S16 for the input vector. In case that the learning is to be ended (YES in step S17), the learning unit 11 acquires the learned model 20 in step S19. As described above, in the learning phase, the learning unit 11 executes the machine learning using the training data to generate the learned model 20.

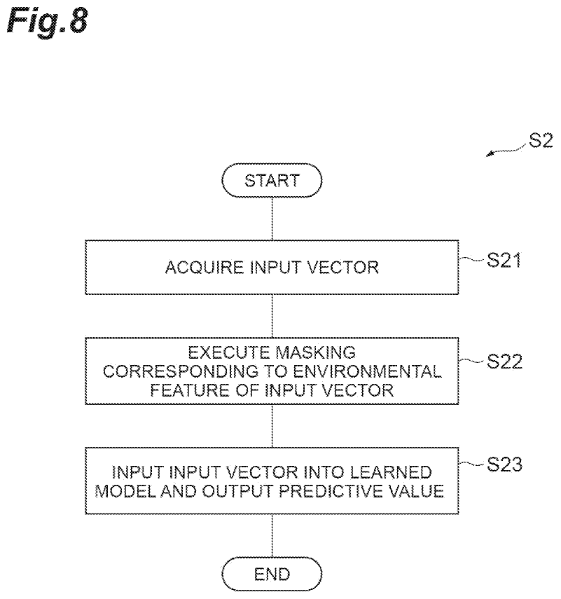

The prediction of the water stress using the learned model 20 will be described with reference to FIG. 8. FIG. 8 is a flowchart showing an example of predicting the water stress by the learned model 20 as a processing flow S2. The processing flow S2 corresponds to the prediction phase and is an example of a prediction method according to the present disclosure.

In step S21, the prediction unit 13 acquires an input vector. The method of acquiring the input vector is not limited. For example, the prediction unit 13 may access a given database to read the input vector, or may acquire the input vector input by a user. Alternatively, the prediction unit 13 may receive the input vector sent from another computer, or may use the input vector generated by a calculation in the prediction system 1.

In step S22, the masking unit 12 executes the masking corresponding to an environmental feature of the input vector. This processing is similar to step S15. That is, the masking unit 12 selects a cluster c to which the environmental feature belongs from the k clusters, and disables some nodes in the neural network 31 according to the mask vector M_{c} corresponding to the cluster c. In one example, the masking unit 12 disables some of the nodes constituting the fully connected layer.

In step S23, the prediction unit 13 inputs the input vector to the learned model 20 and outputs a predictive value obtained by the learned model 20. The method of outputting the predictive value is not limited. For example, the prediction unit 13 may display the predictive value on a monitor, may store the predictive value in a predetermined database, or may transmit the predictive value to another computer system. Alternatively, prediction system 1 may execute further processing using the predictive value.

System Applications

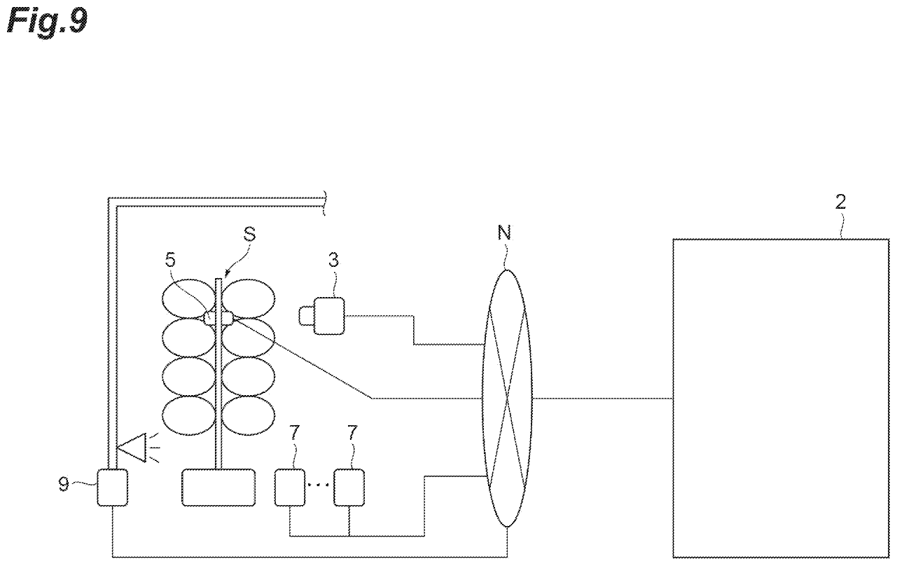

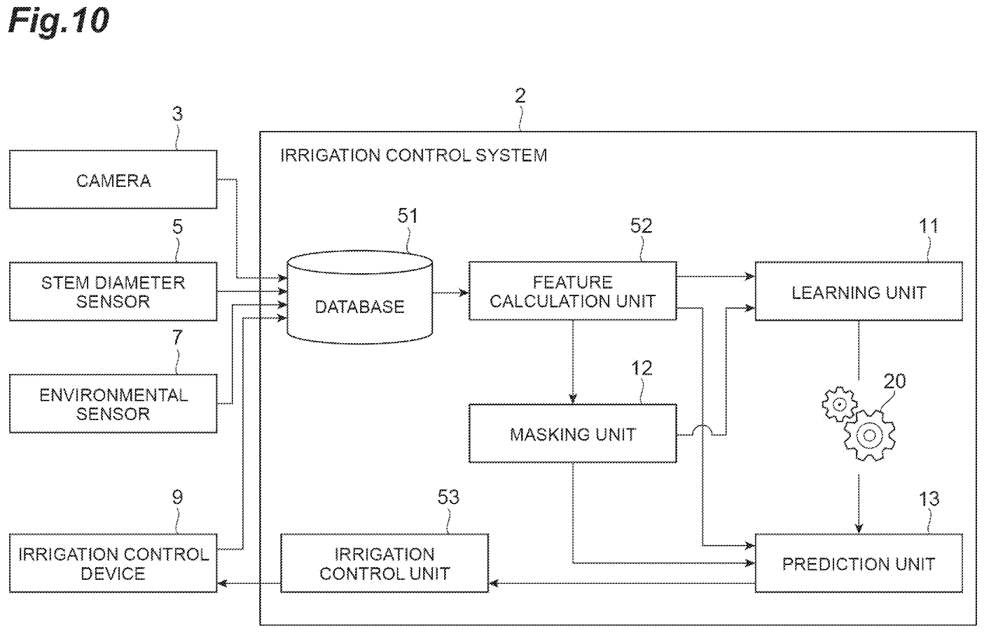

As described above, the prediction system 1 can be used for various purposes. A configuration and operation of an irrigation control system 2, which is an example of an application of the prediction system 1, will be described with reference to FIGS. 9 and 10. FIG. 9 is a diagram showing an example of use of the irrigation control system 2. FIG. 10 shows a functional configuration of the irrigation control system 2.

The irrigation control system 2 is a system that predicts the water stress of a cultivated plant S and controls irrigation of the plant S based on the prediction. The irrigation control system 2 is connected to each of a camera 3, a stein diameter sensor 5, an environmental sensor 7, and an irrigation control device 9 via a wireless or wired communication network N.

The camera 3 is an imaging device that acquires an image of the appearance of the plant S (i.e., a grass figure) at predetermined intervals (e.g., 1-minute intervals, 5-minute intervals, 10-minute intervals, etc.). The position, orientation, and angle of camera 3 are set so as to detect changes in wilting of the plant S. For example, the camera 3 may photograph the entire appearance of the plant S or may photograph only the upper part of the plant S.

The stein diameter sensor 5 is a device that measures the diameter of the stein of the plant S at predetermined intervals (e.g., 1-minute intervals, 5-minute intervals, 10-minute intervals, etc.). The stein diameter sensor 5 is an example of an apparatus for measuring the water stress of the plant S. The stein diameter sensor 5 may be attached to the stein of the plant S. Examples of the stein diameter sensor 5 include, but are not limited to, a laser line sensor including a light projector and a light receiver. Measurement data output from the stein diameter sensor 5 is an actual measurement value of the stein diameter, which is used for training data. This measured value corresponds to the ground truth in the learning phase in the irrigation control system 2, and contributes to processing such as updating of parameters of the neural network 31. In the prediction phase (operation phase), the stein diameter sensor 5 may be omitted.

The environmental sensor 7 is a device for measuring a surrounding environment of the plant S at predetermined intervals (e.g., 1-minute intervals, 5-minute intervals, 10-minute intervals, etc.). The environmental sensor 7 is installed in a cultivation environment of the plant S, for example, around the plant S. The environmental sensor 7 may measure, for example, at least one of temperature, relative humidity, amount of solar radiation (brightness), amount of scattered light (brightness), and photosynthetic photon flux density (PPFD). One environmental sensor 7 may acquire a plurality of types of values, or a plurality of types of environmental sensors 7 may acquire respective values.

The irrigation control device 9 is a device for controlling irrigation to the plant S, for example, a device for controlling the timing or amount of irrigation. Water is supplied to the plant S through a hose under the control of the irrigation control device 9. The irrigation control device 9 may output data indicating whether or not irrigation has been executed.

As shown in FIG. 10, the irrigation control system 2 includes the learning unit 11, the masking unit 12, the prediction unit 13, a database 51, a feature calculation unit 52, and an irrigation control unit 53 as functional elements. In other words, the irrigation control system 2 includes the prediction system 1, the database 51, the feature calculation unit 52, and the irrigation control unit 53. Therefore, in the following, the database 51, the feature calculation unit 52, and the irrigation control unit 53 specific to the irrigation control system 2 will be particularly described.

The database 51 is a device that stores data obtained from the camera 3, the stein diameter sensor 5, the environmental sensor 7, and the irrigation control device 9. This data can be expressed as time series data. The database 51 may store training data used in the learning phase or may store operation data used in the prediction phase (operation phase). In the case of the training data, individual data records corresponding to individual time points may include an image (plant image) obtained from the camera 3, a stein diameter obtained from the stein diameter sensor 5 one or more values (e.g., temperature, humidity, light amount, etc.) obtained from the environmental sensor 7, and control information obtained from the irrigation control device 9. The control information from the irrigation control device 9 may be expressed as two values indicating whether or not irrigation has been executed, and, for example, “1” may indicate that irrigation has been executed, and “0” may indicate that irrigation has not been executed. In the case of the operation data, individual data records corresponding to individual time points may include an image (plant image) obtained from the camera 3 one or more values (for example, temperature, humidity, light amount, etc.) obtained from the environmental sensor 7, and control information obtained from the irrigation control device 9. Since the irrigation control system 2 predicts the water stress in the operation phase, the operation data does not include the stein diameter.

The feature calculation unit 52 is a functional element that calculates at least some feature quantities based on at least some of the data in the database 51. For example, the feature calculation unit 52 may calculate the wilt feature from two images by the method using the optical flow described above. The feature calculation unit 52 may calculate the vapor pressure deficit or may calculate the amount of change in stein diameter.

In one example, the feature calculation unit 52 may provide an input vector to the learning unit 11 or the prediction unit 13, and FIG. 10 shows an example of the data flow. Alternatively, the feature calculation unit 52 may store the input vector in the database 51, and the learning unit 11 or the prediction unit 13 may access the database 51 to acquire the input vector.

The irrigation control unit 53 is a functional element that controls the irrigation of the plant S based on the predictive value of the water stress of the plant S output from the prediction unit 13. For example, the irrigation control unit 53 generates a control signal for controlling at least one of the timing and the amount of irrigation based on the predictive value, and transmits the control signal to the irrigation control device 9. The irrigation control device 9 controls the irrigation based on the control signal, thereby adjusting water stress of the plant S.

Water stress cultivation, which controls irrigation according to water stress of a plant, is known as a technique capable of cultivating fruit having a high sugar content. Although water stress cultivation requires experience, by introducing the irrigation control system 2, even inexperienced farmers can carry out the cultivation method. The stein diameter, which is an index of water stress, and the wilting of the plant are caused by the movement of water in the plant, there is a correlation between the wilting and the stein diameter, and this correlation is affected by a surrounding environment. By applying the prediction system 1, a machine learning model corresponding to various environments is constructed, and thus it is possible to accurately predict the water stress in various surrounding environments. Therefore, control of irrigation is improved, and as a result, effects such as cultivation of fruits having a high sugar content, an increase in yield, and an improvement in salable product rate can be expected.

### Effect

As described above, a prediction system according to an aspect of the present disclosure includes at least one processor. The at least one processor is configured to: acquire a plurality of input vectors indicating a combination of an object feature represented by one or more feature quantities related to a state of an object calculated based on an observation and an environmental feature represented by one or more feature quantities related to a surrounding environment of the object; divide a set of the environmental features into a plurality of clusters by clustering; and execute machine learning for each of the plurality of input vectors to generate a machine learning model for predicting state of object. The machine learning includes: executing processing based on the cluster to which the environmental feature of the input vector belongs; and outputting a predictive value of the state of the object by inputting the input vector into the machine learning model on which the processing is executed.

A prediction method according to an aspect of the present disclosure is executed by a prediction system comprising at least one processor. The prediction method includes: acquiring a plurality of input vectors indicating a combination of an object feature represented by one or more feature quantities related to a state of an object calculated based on an observation and an environmental feature represented by one or more feature quantities related to a surrounding environment of the object; dividing a set of the environmental features into a plurality of clusters by clustering; and executing machine learning for each of the plurality of input vectors to generate a machine learning model for predicting state of object. The machine learning includes: executing processing based on the cluster to which the environmental feature of the input vector belongs; and outputting a predictive value of the state of the object by inputting the input vector into the machine learning model on which the processing is executed.

A prediction program according to an aspect of the present disclosure causes a computer to execute: acquiring a plurality of input vectors indicating a combination of an object feature represented by one or more feature quantities related to a state of an object calculated based on an observation and an environmental feature represented by one or more feature quantities related to a surrounding environment of the object; dividing a set of the environmental features into a plurality of clusters by clustering; and executing machine learning for each of the plurality of input vectors to generate a machine learning model for predicting state of object. The machine learning includes: executing processing based on the cluster to which the environmental feature of the input vector belongs; and outputting a predictive value of the state of the object by inputting the input vector into the machine learning model on which the processing is executed.

In such aspects, the cluster-based processing provides the machine learning model that dynamically changes according to various surrounding environments. By using the machine learning model, the surrounding environment that affects the state of the object is sufficiently considered, and thus the state of the object can be accurately predicted.

In the prediction system according to another aspect, the executing the processing based on the cluster may include executing masking for disabling some nodes of a neural network of the machine learning model based on the cluster to which the environmental feature of the input vector belongs, and the outputting the predictive value may include outputting the predictive value by inputting the input vector into the machine learning model on which the masking is executed.

In this aspect, since the machine learning is executed while some of the nodes constituting the neural network are disabled or enabled according to the cluster (i.e., the classification of the surrounding environment), a machine learning model that dynamically changes according to various surrounding environments may be obtained. By using this machine learning model, the surrounding environment that affects the state of the object is sufficiently considered, and thus the state of the object can be accurately predicted.

In the prediction system according to another aspect, the at least one processor may be further configured to generate a plurality of mask vectors corresponding to the plurality of clusters. Each of the plurality of mask vectors may indicate which node of a plurality of nodes is to be disabled. The masking may be executed based on the mask vector corresponding to the cluster to which the environmental feature of the input vector belongs. By using the mask vector, the masking can be efficiently executed.

In the prediction system according to another aspect, the at least one processor may be further configured to: set initial values of the plurality of mask vectors as initial mask vectors such that the initial values of the plurality of mask vectors are different from each other; and for each of the plurality of clusters, set a logical sum of the initial mask vector of the cluster and the initial mask vector of each of one or more of clusters located near the cluster, as the mask vector of the cluster. By setting the mask vectors in such a procedure, each mask vector is set so as to adapt to a corresponding type of surrounding environment, and thus the masking can be executed appropriately.

In the prediction system according to another aspect, at least one of the one or more feature quantities of the state of the object may be set based on an optical flow calculated using the observation. By using the optical flow, the state of the object can be appropriately represented, and the state can be predicted more accurately.

In the prediction system according to another aspect, the observation may be an image of a plant, the object may be the plant, the object feature may be a wilt feature, and the machine learning model may be for predicting a water stress of the plant. In this case, since the surrounding environment that affects the state of the plant is sufficiently considered, the water stress of the plant can be predicted accurately.

In the prediction system according to another aspect, the one or more feature quantities of the environmental feature may include at least one of temperature, relative humidity, vapor pressure deficit, and an amount of scattered light. By taking these environmental factors into consideration, the water stress of the plant can be predicted more accurately.

In the prediction system according to another aspect, each of the plurality of input vectors may be configured using a vector that is a combination of the wilt feature and a common feature and a vector that is a combination of the environmental feature and the common feature. The common feature may be a feature complementing each of the wilt feature and the environmental feature. By introducing such a common feature, factors related to both the state of the plant and the surrounding environment are considered in the machine learning, and thus the water stress of the plant can be predicted more accurately.

In the prediction system according to another aspect, one or more feature quantities of the common feature may include at least one of an elapsed time from sunrise and an irrigation flag indicating whether or not irrigation has been performed. By considering these factors, the water stress of the plant can be predicted more accurately.

In the prediction system according to another aspect, the masking may include disabling some of a plurality of nodes constituting a fully connected layer of the neural network. Since masking for a fully connected layer can be realized relatively easily, the processing load of the prediction system related to the masking can be suppressed.

An irrigation control system according to an aspect of the present disclosure includes the above prediction system. The at least one processor is further configured to control irrigation to the plant based on the predictive value. In this aspect, the water stress of the plant can be accurately predicted by sufficiently considering the surrounding environment that affects the state of the plant, and thus, irrigation can be appropriately executed based on the accurate prediction.

### Example of Effect

In low-stage dense planting of tomatoes called Frutica, the cultivation method (Example) using the prediction system of the present disclosure was compared with solar radiation proportional irradiation, which is Comparative Example. In both Example and Comparative Examples, each nursery plant was planted in a 6 cm×6 cm×6 cm rockwool cube and grown in a greenhouse. The plant density was 148 plants per 1 m². In Comparative Example, a skilled fanner measured sunlight with an illuminance sensor and determined and controlled the amount of irrigation based on the illuminance value.

The tomatoes had an average brix of 8.87 and a maximum brix of 16.9 in Example, whereas the tomatoes had an average brix of 8.73 and a maximum brix of 15.7 in Comparative Example. The average fruit weight was 20.8 g in Example and 22.8 g in Comparative Example. The salable product rate, which indicates a ratio of tomatoes that can be sold (in other words, the ratio of tomatoes having no abnormality such as cracking, rotting, or discoloration) was 0.917 in Example and 0.826 in Comparative Example. It has been found that the prediction system of the present disclosure can improve the quality of plants while reducing the labor of cultivation.

### Modification

The present disclosure has been described above in detail based on the embodiments. However, the present disclosure is not limited to the above embodiments. The present disclosure can be variously modified without departing from the gist thereof.

The functional configuration of the prediction system is not limited to the above embodiments. As described above, since the prediction system does not have to execute one of the learning phase and the prediction phase, it does not have to include a functional element corresponding to one of the learning unit 11 and the prediction unit 13. Therefore, the prediction system does not have to execute one of the processing flows S1 and S2.

In the above embodiment, the prediction system 1 processes the wilt features, environmental features, and common features, but the prediction system may process additional features. For example, the prediction system may input a vector including a feature based on voice or video into the machine learning model.

The above embodiments show an example in which the masking unit 12 disables some of the plurality of nodes constituting the fully connected layer of the neural network 31. However, the layer to which the masking is applied is not limited to the fully connected layer, and the masking unit may disable some nodes in any layer of the neural network.

In the above embodiments, the cluster-based processing includes the masking, but that processing is not limited to the masking and may be designed according to any policy.

In the present disclosure, the expression of “at least one processor executes a first processing, executes a second processing, . . . , executes a n-th processing” or the corresponding wordings indicate a concept including a case where a subject (i.e., processor) that executes processes from the first processing to the n-th processing is changed in the middle. In other words, this expression indicates a concept including both a case where all of the n processes are executed by the same processor and a case where the processor is changed by any policy in the n pieces of processing.

A processing procedure of a method executed by at least one processor is not limited to the examples in the above embodiments. For example, some of the steps described above may be omitted, or each step may be executed in a different order. In addition, two or more arbitrary steps among the above-described steps may be combined, or a part of the steps may be modified or deleted. Alternatively, other steps may be executed in addition to the above steps.

In a comparison of a magnitude relationship between two numbers, either of the two criteria “greater than or equal to” and “greater than” may be used, and either of the two criteria “less than or equal to” and “less than” may be used. Such a selection of the criterion does not change the technical significance of the processing of comparing the magnitude relationship between two numbers.

### REFERENCE SIGNS LIST

1: prediction system, 2: irrigation control system, 3: camera, 5: stein diameter sensor, 7: environmental sensor, 9: irrigation control device, 11: learning unit, 12: masking unit, 13: prediction unit, 20: learned model, 30: machine learning model, 31: neural network, 51: database, 52: feature calculation unit, 53: irrigation control unit, 110: prediction program, S: plant.

1. A prediction system comprising:
at least one processor,
wherein the at least one processor is configured to:
acquire a plurality of input vectors indicating a combination of an object feature represented by one or more feature quantities related to a state of an object calculated based on an observation and an environmental feature represented by one or more feature quantities related to a surrounding environment of the object;
divide a set of the environmental features into a plurality of clusters by clustering; and
execute machine learning for each of the plurality of input vectors to generate a machine learning model for predicting state of object, and
wherein the machine learning comprises:
executing processing based on the cluster to which the environmental feature of the input vector belongs; and
outputting a predictive value of the state of the object by inputting the input vector into the machine learning model on which the processing is executed.

2. The prediction system according to claim 1,
wherein the executing the processing based on the cluster comprises executing masking for disabling some nodes of a neural network of the machine learning model based on the cluster to which the environmental feature of the input vector belongs, and
wherein the outputting the predictive value comprises outputting the predictive value by inputting the input vector into the machine learning model on which the masking is executed.

3. The prediction system according to claim 2,
wherein the at least one processor is further configured to generate a plurality of mask vectors corresponding to the plurality of clusters, each of the plurality of mask vectors indicating which node of a plurality of nodes is to be disabled, and
wherein the masking is executed based on the mask vector corresponding to the cluster to which the environmental feature of the input vector belongs.

4. The prediction system according to claim 3,
wherein the at least one processor is further configured to:
set initial values of the plurality of mask vectors as initial mask vectors such that the initial values of the plurality of mask vectors are different from each other; and
for each of the plurality of clusters, set a logical sum of the initial mask vector of the cluster and the initial mask vector of each of one or more of clusters located near the cluster, as the mask vector of the cluster.

5. The prediction system according to claim 2, wherein the masking comprises disabling some of a plurality of nodes constituting a fully connected layer of the neural network.

6. The prediction system according to claim 2, wherein at least one of the one or more feature quantities of the state of the object is set based on an optical flow calculated using the observation.

7. The prediction system according to claim 2,
wherein the observation is an image of a plant,
the object is the plant,
the object feature is a wilt feature, and
the machine learning model is for predicting a water stress of the plant.

8. The prediction system according to claim 7, wherein the one or more feature quantities of the environmental feature include at least one of temperature, relative humidity, vapor pressure deficit, and an amount of scattered light.

9. The prediction system according to claim 7, wherein each of the plurality of input vectors is configured using a vector that is a combination of the wilt feature and a common feature and a vector that is a combination of the environmental feature and the common feature, the common feature being a feature complementing each of the wilt feature and the environmental feature.

10. The prediction system according to claim 9, wherein one or more feature quantities of the common feature include at least one of an elapsed time from sunrise and an irrigation flag indicating whether or not irrigation has been performed.

11. The prediction system according to claim 7,
wherein the at least one processor is further configured to control irrigation to the plant based on the predictive value.

12. A prediction method executed by a prediction system comprising at least one processor, the prediction method comprising:
acquiring a plurality of input vectors indicating a combination of an object feature represented by one or more feature quantities related to a state of an object calculated based on an observation and an environmental feature represented by one or more feature quantities related to a surrounding environment of the object;
dividing a set of the environmental features into a plurality of clusters by clustering; and
executing machine learning for each of the plurality of input vectors to generate a machine learning model for predicting state of object,
wherein the machine learning comprises:
executing processing based on the cluster to which the environmental feature of the input vector belongs; and
outputting a predictive value of the state of the object by inputting the input vector into the machine learning model on which the processing is executed.

13. A non-transitory computer-readable storage medium storing a prediction program causing a computer to execute:
acquiring a plurality of input vectors indicating a combination of an object feature represented by one or more feature quantities related to a state of an object calculated based on an observation and an environmental feature represented by one or more feature quantities related to a surrounding environment of the object;
dividing a set of the environmental features into a plurality of clusters by clustering; and
executing machine learning for each of the plurality of input vectors to generate a machine learning model for predicting state of object,
wherein the machine learning comprises:
executing processing based on the cluster to which the environmental feature of the input vector belongs; and
outputting a predictive value of the state of the object by inputting the input vector into the machine learning model on which the processing is executed.
